(19) United States
(12) Patent Application Publication
(10) Pub. No.: US 2017/0302086 A1
(43) Pub. Date: Oct. 19, 2017

(54) INDUCTIVE POWER TRANSFER SYSTEM

(71) Applicant: Drayson Technologies (Europe) Limited, London (GB)

(72) Inventors: Christopher Howe Kwan, Greater London (GB); Manuel Pinuela Rangel, Greater London (GB); Paul Mitcheson, Greater London (GB); David Yates, Greater London (GB)

(21) Appl. No.: 15/515,908

(22) PCT Filed: Sep. 25, 2015
(86) PCT No.: PCT/EP2015/072106

§ 371 Date: Mar. 30, 2017

(30) Foreign Application Priority Data
Sep. 30, 2014 (GB) 1417315.7

(51) Int. Cl. H02J 5/00; H02J 7/02; H02J 50/20

(52) U.S. Cl. CPC H02J 5/005; H02J 50/20; H02J 7/025

(57) ABSTRACT

There is provided a near-field inductive power transfer system (10), comprising a power transmission device (100) arranged to transmit power wirelessly at a first frequency, f₀, and a power reception device (200) arranged to receive power transmitted by the power transmission device (100). The power reception device (200) is moveable relative to the power transmission device (100) and comprises a receiver circuit (210) configured to receive power for powering a variable load (230) when the power reception device (200) is in a near-field region of the power transmission device (100), the receiver circuit being a resonant circuit with a resonant frequency, f_{R}, such that 0.2<f₀/f_{R}<3. The power reception device (200) also includes an impedance emulator (220) for providing the received power to the variable load (230), the impedance emulator being arranged to suppress a variation in an impedance presented to the receiver circuit (210) by the load when the load varies during use of the near-field inductive power transfer system (10).

### CLAIM OF PRIORITY

This patent application claims priority from UK patent application number 1417315.7 filed on Sep. 30, 2014, the full contents of which are incorporated herein by reference.

### TECHNICAL FIELD

The present invention generally relates to the field of near-field inductive power transfer systems, and more specifically to a power reception device for powering a variable load using power received via a resonant or semi-resonant inductive link to a power transmission device, and a near-field IPT system comprising such power transmission device and power reception device.

### BACKGROUND

The wireless transmission of power has attracted considerable interest over the past century, ever since Nikola Tesla proposed theories of wireless power transmission in the late 1800s. The wireless power transmission techniques that have since been developed have conventionally been categorised as being either “far-field” or “near-field”. Far-field power transmission techniques employ radiative electromagnetic fields (typically at radio or microwave frequencies) to transfer power to a receiver in the far-field region of the transmitter's antenna. For an electromagnetically short antenna (i.e. an antenna which is shorter than the half of the wavelength λ of the radiation it emits), the far-field region is generally taken to cover distances from the antenna that are greater than 2λ. The near-field region of an electromagnetically short antenna is conventionally taken to extend up to the distance of λ from the antenna. In the case of an electromagnetically long antenna, the boundary between the near-field and far-field regions is set by the Fraunhofer distance, namely 2D²/λ, where D is the largest dimension of the antenna. Although far-field wireless power transfer over distances of several kilometres has been demonstrated, it is, by its nature, relatively inefficient and its techniques are better suited for use in telecommunications, where an adequate signal-to-noise (rather than high power efficiency) is required.

Following the widespread deployment of wired power distribution networks (including power grids such as the National Grid in the UK) that distribute electricity efficiently over large distances to almost everywhere, and driven by the considerable commercial and environmental value in finding a way of conveniently and efficiently charging or powering the rapidly growing array of portable consumer electronics (including mobile phones and PDAs) and household electrical items (such as electric toothbrushes, TVs, sound systems etc.) on the market without resorting to customised charging adapters, more recent research has focused on wireless power transfer for medium range (i.e. 10 s of cm) applications. There has therefore been considerable interest in developing known near-field inductive power transfer (IPT) systems, which rely on magnetic inductive coupling between the coils (or equivalent inductive elements) of a transmitter and receiver.

The distance over which the non-radiative electromagnetic field can transfer power in a near-field IPT system can be increased by exploiting the phenomenon of resonance. In a near-field resonant IPT system, each of the transmitter coil and the receiver coil is capacitively loaded so as to form a respective resonant LC circuit, with the two resonant circuits in the system being tuned to have the same or similar natural frequencies. In this way, significant power can be transmitted between the coils over a range of a few times the coil diameter, with reasonable efficiency.

### SUMMARY

The present inventors have recognised that changes in the load of a near-field resonant IPT system receiver, which occur in many practical applications, have the effect of lowering the system's efficiency, owing to the near-field coupling that occurs between the transmitter and receiver coils. More particularly, the inventors have recognised that this coupling causes a varying receiver load to be manifested as a changing effective resistance in the transmitter's resonant circuit, leading to an impedance mismatch in the transmitter that lowers its efficiency. The inventors have solved this problem by providing the receiver with an impedance emulator connected between the receiver's resonant circuit and its load circuitry. The impedance emulator (which may take one of many different forms, including an H-bridge or a switched mode DC-DC converter, among others) is configured to suppress a variation in the impedance presented to the receiver's resonant circuit by the load when the load varies during use of the near-field. IPT system, thereby allowing the IPT system to remain tuned for high-efficiency energy transfer while the load changes during operation. In one embodiment, the impedance emulator is configured to present a substantially constant impedance to the receiver's resonant circuit when the load varies during use, the impedance preferably being set to a value that maximises the power transferred.

More specifically, the inventors have devised a near-field IPT system, comprising a power transmission device arranged to transmit power wirelessly at a first frequency, f₀, and a power reception device arranged to receive power transmitted by the power transmission device. The power reception device is moveable relative to the power transmission device and comprises a receiver circuit configured to receive power for powering a variable load when the power reception device is in a near-field region of the power transmission device, the receiver circuit being a resonant circuit with a resonant frequency, f_{R}, such that 0.2<f₀/f_{R}<3.

The power reception device further comprises an impedance emulator for providing the received power to the variable load, the impedance emulator being arranged to suppress a variation in an impedance presented to the receiver circuit by the load when the load varies during use of the near-field inductive power transfer system.

The inventors have further devised a mobile power reception device for receiving power that has been transmitted wirelessly by a power transmission device at a first frequency, f₀. The power reception device comprises a receiver circuit configured to receive power for powering a variable load when the power reception device is in a near-field region of the power transmission device, the receiver circuit being a resonant circuit with a resonant frequency, f_{R}, such that 0.2<f₀/f_{R}<3. The power reception device further comprises an impedance emulator for providing the received power to the variable load, the impedance emulator being arranged to suppress a variation in an impedance presented to the receiver circuit by the load when the load varies during use of the near-field inductive power transfer system.

The inventors have further devised a power transmission device for transmitting power wirelessly to a mobile power reception device at a frequency f₀ when the power reception device is in a near-field region of the power transmission device, the power reception device comprising a resonant circuit having a resonant frequency f_{R} such that 0.2<f₀/f_{R}<3. The power transmission device comprises a power transmission module for transmitting power wirelessly to the power reception device, and a feedback signal receiver operable to receive from the power reception device a feedback signal indicative of an output voltage of the resonant circuit measured by the power reception device. The power transmission device further comprises a transmission power controller arranged to control the power transmitted by the power transmission module in dependence upon the received feedback signal.

In a power transmission device according to an embodiment, the power transmitted by the power transmission module can be controlled on the basis of a signal indicative of a single parameter, namely the output voltage of the resonant circuit as measured by the power reception device. This simplified control scheme is made possible by the function of the aforementioned impedance emulator in the power reception device.

### BRIEF DESCRIPTION OF THE DRAWINGS

Embodiments of the invention will now be explained in detail, by way of example only, with reference to the accompanying figures, in which:

FIG. 1 is schematic illustration of a near-field IPT system according to a first embodiment of the present invention;

FIG. 2 is schematic illustration of a near-field. IPT system according to a second embodiment of the present invention;

FIG. 3 shows a simplified equivalent circuit diagram of the receiver coil, bridge rectifier and flyback impedance emulator shown in FIG. 2;

FIG. 4 is a flow chart illustrating the process by which the transmission power is controlled by the transmission power controller on the basis of the feedback signal from the receiver;

FIG. 5 shows experimental results which illustrate how the received power varies with distance of the receiver from the transmitter when the feedback signal is used to regulate the transmission power; and

FIG. 6 shows experimental results which illustrate how the impedance of the impedance emulator varies with its input voltage.

### DETAILED DESCRIPTION OF EMBODIMENTS

### First Embodiment

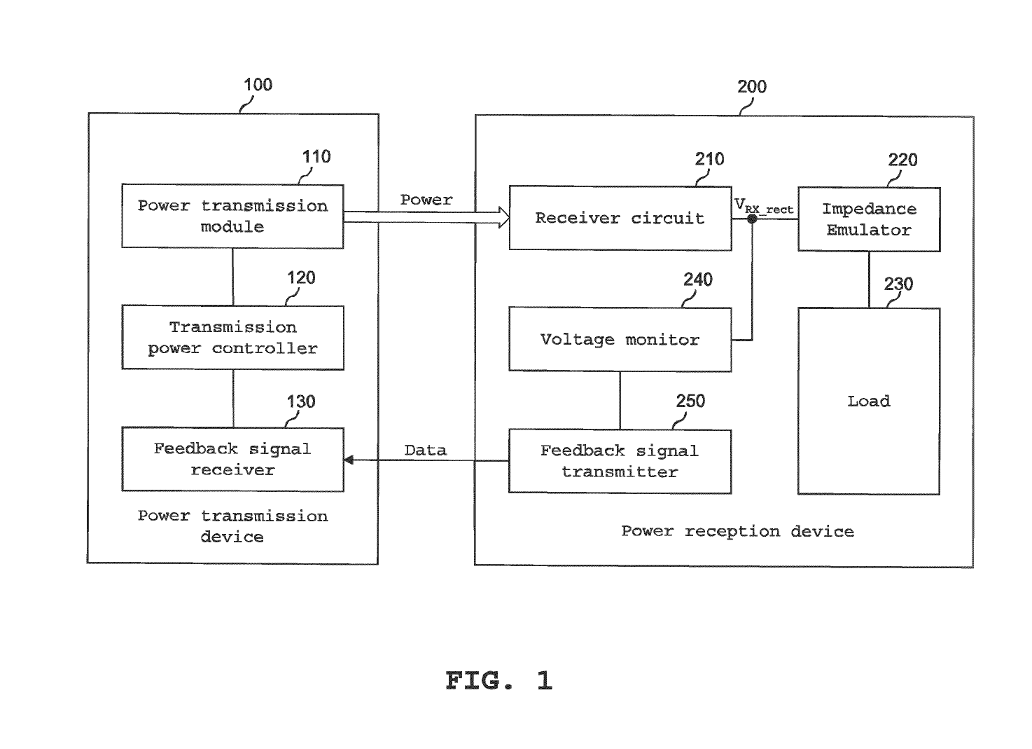

FIG. 1 is a schematic illustrating components of a near-field inductive power transfer (IPT) system 10 according to a first embodiment of the present invention.

As illustrated in FIG. 1, the IPT system 10 comprises a power transmission device 100 that is configured to transmit power wirelessly at a predetermined frequency, f₀, to a power reception device 200.

The power transmission device 100 comprises a power transmission module 110 having a resonant circuit that includes an inductive element, such as a coil antenna. The power transmission module 110 is configured to generate a non-radiative electromagnetic field with a predominantly magnetic part that transfers energy to the power reception device 200 by inductive coupling when the power reception device 200 is located in a near-field region of the power transmission device 100. The power transmission device 100 may, as in the present embodiment, also include a transmission power controller 120 arranged to control the level of power output by the power transmission module 110, and a feedback signal receiver 130 for receiving a feedback signal from the power reception device 200, on the basis of which the transmission power controller 120 may control the output power level.

The power reception device 200 shown in FIG. 1 is a mobile device which is separate from, and moveable relative to, the power transmission device 100. The power reception device 200 may take one of many different forms. For example, in some embodiments, the power reception device 200 is a wireless charging circuit in an electric vehicle, and the power transmission device 100 is provided in the exemplary form of a wireless charging station over which the electric vehicle is parked to charge its battery. However, it will be appreciated that the techniques described herein can be used in many other applications. For example, in other embodiments, the power reception device 200 may be a sensor (e.g. a flow rate monitor concealed in a pipe), a wearable/attachable device (e.g. a fitness tracker or a smart watch) or an implantable medical device (such as an implantable pump for dispensing medication or a monitor for monitoring e.g. a person's blood sugar level), for example.

The power reception device 200 comprises a receiver circuit 210, which is arranged to receive the transmitted power by induction when the power reception device 200 is in the near-field region of the power transmission device 100. It should be noted that the receiver circuit 210 is configured to receive substantial power from the power transmission module 110 only when the power reception device 200 is in the near-field region of the power transmission device 100. The transferred power decreases rapidly when the power reception device 200 is moved outside the near-field region, and is negligible (practically zero) in the far-field region of the power transmission device 100.

For improved energy transfer efficiency, and in order to decrease the component count, the transmitter's tank and the receiver's circuit 210 are both resonant circuits. The receiver's circuit 210 has a resonant frequency f_{R} and is caused to oscillate at resonance or semi-resonance by the magnetic field generated by the power transmission device 100, which oscillates at the frequency f₀. More particularly, resonant or semi-resonant operation of the inductive power transfer system 10 is achieved when the ratio f₀/f_{R} is between 0.2 and 3.

The receiver circuit 210 uses the received power to power a variable load 230 via an impedance emulator 220. As will be explained in more detail below, the impedance emulator 220 suppresses the variation in the impedance presented to the receiver circuit 210 by the load 230 when the load 230 draws a varying level of current during operation of the IPT system 10. In some embodiments, the impedance emulator 220 presents a substantially constant effective impedance to the receiver circuit 210 when the load current varies during use. In this case, the change in the effective impedance may be several times (e.g. by a factor of 2-5) or preferably at least an order of magnitude (or, more preferably, two or three orders of magnitude) smaller than in the case where no impedance emulator is connected between the receiver circuit 210 and the load 230.

In addition, the power reception device 200 may, as in the present embodiment, further comprise a voltage monitor 240 arranged to measure the output voltage, V_{RX}_{_}_{rect}, of the receiver circuit 210, and a feedback signal transmitter 250 arranged to generate and transmit a feedback signal indicative of the measured output voltage V_{RX}_{_}_{rect} to the feedback signal receiver 130 of the power transmission device 100. The voltage monitor 240 and the feedback signal transmitter 250 may, as in the present embodiment, also receive the power required for their operation from the output of the impedance emulator 220, and may be implemented using techniques well-known to those skilled in the art.

In embodiments like the present, where the power reception device 200 includes the voltage monitor 240 and feedback signal transmitter 250, the transmission power controller 120 is preferably configured to regulate the power transmitted by the power transmission device 100 by monitoring a difference between V_{RX}_{_}_{rect} and a reference voltage, V_{ref}, and adjusting the transmitted power based on the monitored difference, for example to minimise the difference (V_{RX}_{_}_{rect}−V_{ref}) and thus keep the output voltage V_{RX}_{_}_{rect} at a predetermined level, e.g. 50 V. The transmission power controller 120 may additionally or alternatively be configured to control the transmitted power to remain below a first limit so as to prevent the power transmission device 100 from sustaining damage by operating above its power output limit. As a further or alternative feature, the transmission power controller 120 may be configured to compare the measured output voltage V_{RX}_{_}_{rect} with a threshold voltage, V_{RX}_{_}ₘₐₓ, and to cause the power transmission module 110 to cease transmitting power, or to transmit power at an appropriate reduced level, when V_{RX}_{_}_{rect}>V_{RX}_{_}ₘₐₓ, in order to prevent an excessively high voltage being induced in the power reception device 200, which could damage some of its components.

It should be noted that, for any combination of one or more of the aforementioned configurations of the transmission power controller 120, the associated functionality can be achieved by feeding back from the power reception device 200 to the power transmission device 100 an indicator of a single measured voltage, namely V_{RX}_{_}_{rect}. The simplicity of this control scheme provides considerable advantages, particularly in low-power applications, as the overheads associated with measuring, processing and communicating further measured voltage or current values can be avoided. This simplification is made possible by the use of the impedance emulator 220 in the power reception device 200, as will become clear from the following description.

### Second Embodiment

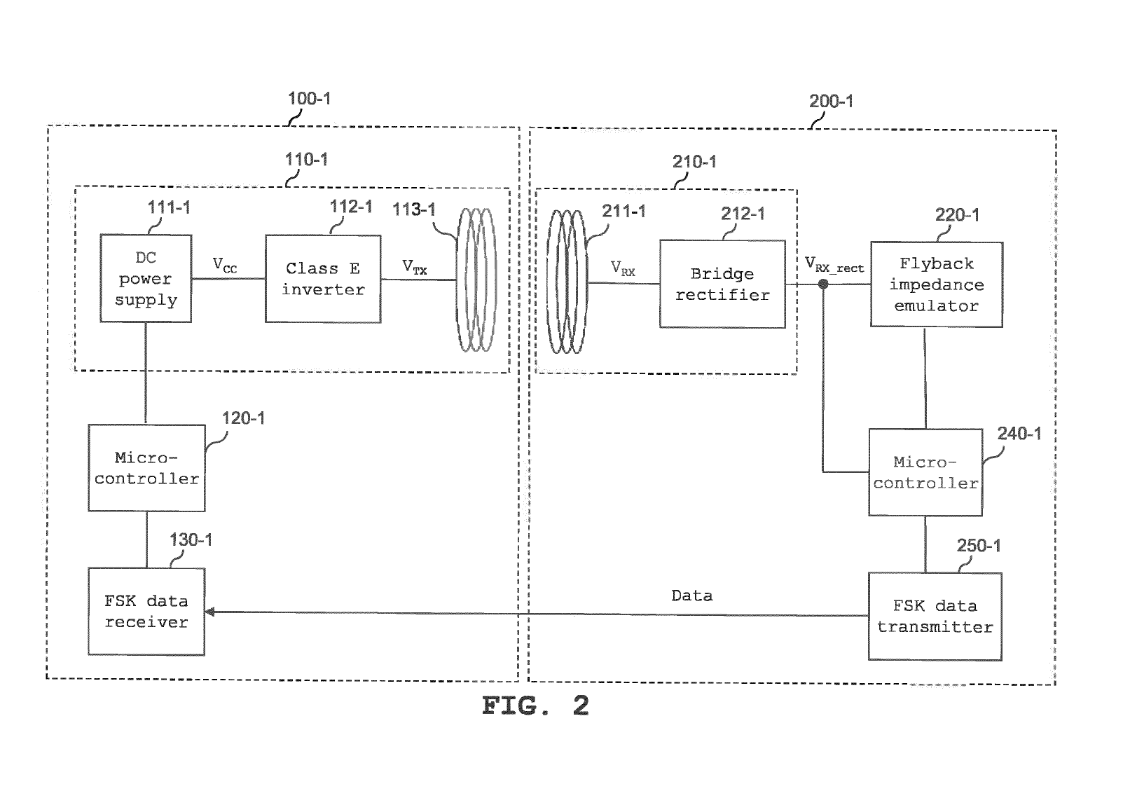

FIG. 2 is a schematic showing one possible practical implementation of the IPT system 10 shown in FIG. 1, which constitutes a second embodiment of the present invention. This IPT system employs a semi-resonant Class-E topology power amplifier in the transmitter, and is suitable for long-range powering of sensors with mW-level consumption.

The power transmission module 110-1 (as an example of the power transmission module 110 of FIG. 1) comprises a resonant circuit having an inductor, and a drive circuit that is arranged to drive the inductor so as to generate a changing magnetic field that transfers energy to the power reception device 200-1. More specifically, in the embodiment of FIG. 2, the drive circuit comprises a DC power supply 111-1, which is arranged to supply a DC voltage V_{cc} to power a Class-E inverter 112-1. The Class-E inverter is arranged to drive the resonant circuit comprising the inductor (which is provided in the exemplary form of a transmission coil 113-1) with a drive signal V_{TX} whose frequency f₀ may be slightly above or below the resonant circuit's natural frequency. As explained in co-pending application CA2817288 (A1), this semi-resonant operation can increase driver and link efficiencies and reduce the number of components required.

The amplitude of the voltage V_{cc} output by the DC power supply 111-1 is controlled by a signal or data processing device which, by way of example, is provided in the form of a microcontroller 120-1. Although the transmission power controller 120 shown in FIG. 1 is implemented in the form of a programmable microcontroller 120-1 in the present embodiment, the transmission power controller 120 may alternatively be provided in the form of a dedicated signal processing device such as an ASIC or a FPGA.

The control performed by the microcontroller 120-1 shown in FIG. 2 is based on a feedback signal that has been received by the frequency shift keying (FSK) data receiver 130-1 (as an example of the feedback signal receiver 130 shown in FIG. 1), via a 433 MHz wireless link (although other frequencies may, of course, be used). In other embodiments, instead of FSK, the feedback signal may be encoded using one of the many other modulation schemes known to those skilled in the art.

On the power reception side, the receiver circuit 210 of FIG. 1 may be configured, as shown in FIG. 2, to include a receiver coil 211-1 and a rectifying circuit in the exemplary form of a semi-resonant Class-E bridge rectifier 212-1 as illustrated. Of course, another kind of rectifier may alternatively be used. The bridge rectifier 212-1 rectifies the AC voltage induced in the receiver coil 211-1 to generate a rectified receiver voltage V_{RX}_{_}_{rect}, which is input to an impedance emulator.

As noted above, the impedance emulator may take one of many difference forms. By way of example, the impedance emulator is a flyback-topology switched mode DC-DC converter (also widely referred to as a “switched mode power supply”) 220-1 in the present embodiment. The flyback converter 220-1 provides the received power to the load, which includes the downstream microcontroller 240-1 (as an example of the voltage monitor 240) and the FSK data transmitter 250-1 (as an example of the feedback signal transmitter 250) in the present embodiment.

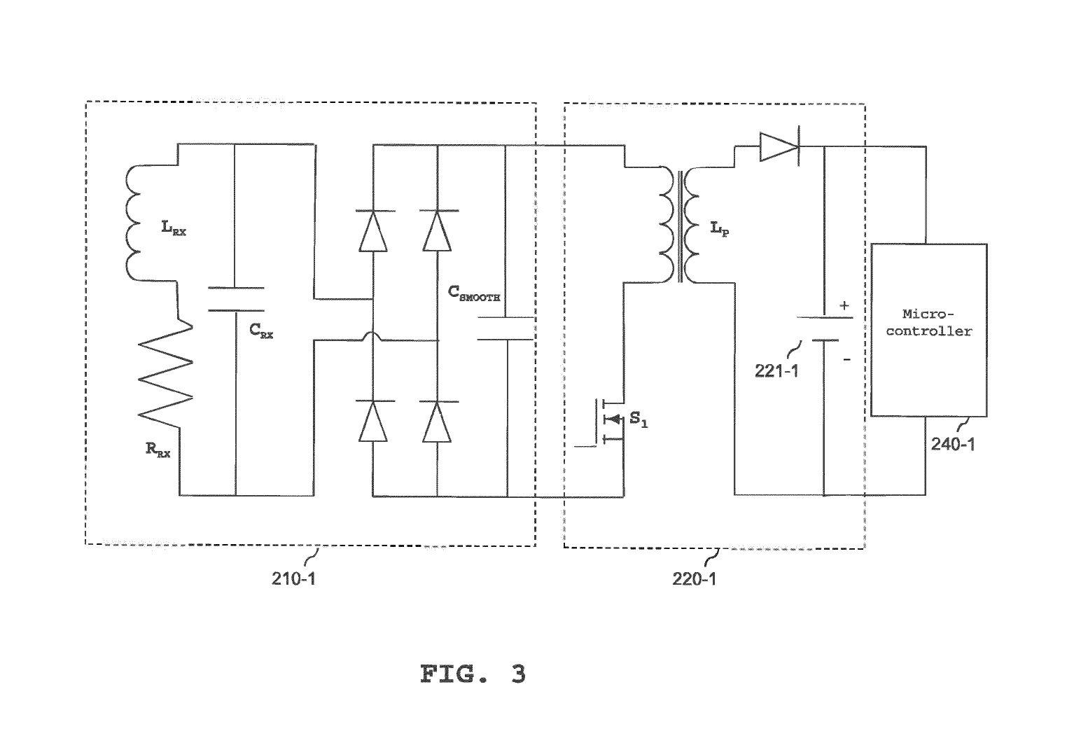

A simplified circuit diagram including the receiver coil 211-1, the bridge rectifier 212-1, the flyback converter 220-1 and the microcontroller 240-1 of the present embodiment is shown in FIG. 3. The receiver coil 211-1 is represented by the series combination of the inductor L_{RX} and resistor R_{RX}, and is connected in parallel with the tuneable capacitor C_{RX} to provide a resonant LCR circuit. In this embodiment, the receiver also operates in semi-resonance, with the ratio of the switching frequency f₀ in the transmitter to the resonant frequency f_{R} of the receiver's LCR circuit satisfying 0.2<f₀/f_{R}<3. However, in other embodiments, the resonant circuits of both the transmitter and receiver may operate at a common resonant frequency.

The output of the receiver's resonant circuit is rectified by a full-wave rectifier comprising four diodes that are interconnected as shown, before being passed to the flyback converter 220-1. In the present embodiment, the flyback converter 220-1 is operated in open loop (i.e. with a fixed switching duty ratio) and in the Discontinuous Conduction Mode (DCM). In this mode of operation, the flyback converter 220-1 draws a level of power from the receiver circuit 210-1 that is substantially unchanged when the load current (including that drawn by the microcontroller 240-1 and the FSK data transmitter 250-1) varies during use of the IPT system. In other words, the flyback converter 220-1 receives from the receiver circuit 210-1, in each switching period, an amount of energy that is substantially independent of the load current and thus substantially constant when the load current varies during use. This property enables the flyback converter 220-1 (as an example of the impedance emulator 220 shown in FIG. 1) to suppress the variation in the impedance presented to the receiver circuit 210-1 when the load varies during use, and can be understood by considering the amount of energy stored in the flyback converter's inductor during a switching period. More particularly, the amount of energy stored can be shown to be (V_{RX}_{_}_{rect}τ)²/2Lₚ, where τ represents the time for which the switch S₁ of the flyback converter 220-1 conducts in each switching period Tₛ, and Lₚ represents the inductance of the flyback converter's inductor. Equating the power input to the flyback converter 220-1, (V_{RX}_{_}_{rect}τ)²/2TₛLₚ, with the power dissipated by an equivalent impedance Z (i.e. V²_{RX}_{_}_{rect}/Z) leads to the following expression for the effective input impedance Z that is presented to the receiver circuit 210-1:

Z=2fₛLₚ/D²

Thus, Z is dependent on the flyback converter's switching frequency (fₛ=1/Tₛ), the inductance Lₚ and the switching duty ratio D=τ/Tₛ but not on the flyback converter's load. The value of the impedance Z is preferably set to a value that maximises the power transferred in the IPT system. This value may be determined experimentally or it may be calculated. For example, in the case of a long-range IPT system (effective for distances up to about 10 m), where the coupling between the transmitter and receiver is extremely weak, the optimal impedance Zₒₚₜ may be easily determined as it is simply the conjugate match of the receiver's resonant tank at the operating frequency. Thus,

$${Z}_{opt} = {( \frac{1}{\frac{1}{{R}_{RX}} + j ω {L}_{RX} + j ω {C}_{RX}} )}^{*}$$

where ω is the operating frequency of the system multiplied by 2n, and (x)* represents the complex conjugate of x. In the present embodiment, fₛ=19 kHz, Lₚ=140 mH and D=0.24, so that Z=92.4 which is close to the optimal impedance presented to the rectifier. It can be shown that the flyback converter 220-1 will operate in DCM provided D≦1/(1+Vᵢₙ/nVₒᵤₜ), where Vᵢₙ and Vₒᵤₜ are respectively the input voltage and the output voltage of the flyback converter 220-1, and n is the turns ratio.

In the present embodiment, the flyback converter 220-1 comprises a battery 221-1 connected in parallel with the microcontroller 240-1, as shown in FIG. 3. The battery 221-1 provides the well-known function of the output capacitor that is conventionally provided instead of the battery 221-1 in a flyback converter topology and, in addition, serves to provide power to the load circuitry (including the microcontroller 240-1) when the power reception device 200 is out of range of the power transmission device 100 or is not receiving transmitted power for any other reason.

It should be noted, however, that the flyback converter is only one example of a switched mode DC-DC converter that may be used to emulate a substantially constant impedance. There are many other switching converter topologies that may be used to provide the same function, all of which may operate at a similarly high level of efficiency as the flyback converter. For example, in other embodiments, the power reception device 200-1 may have an impedance emulator in the form of a zeta converter, a buck-boost converter, a SEPIC converter or a Ćuk converter, which is configured to operate (in DCM in some examples) as an impedance emulator. As yet further alternatives, a boost converter with a step-up voltage conversion ratio much greater than unity (e.g. greater than 10), or a buck converter with a step-down voltage conversion ratio much greater than unity (e.g. greater than 10), could also be used to emulate a substantially constant impedance.

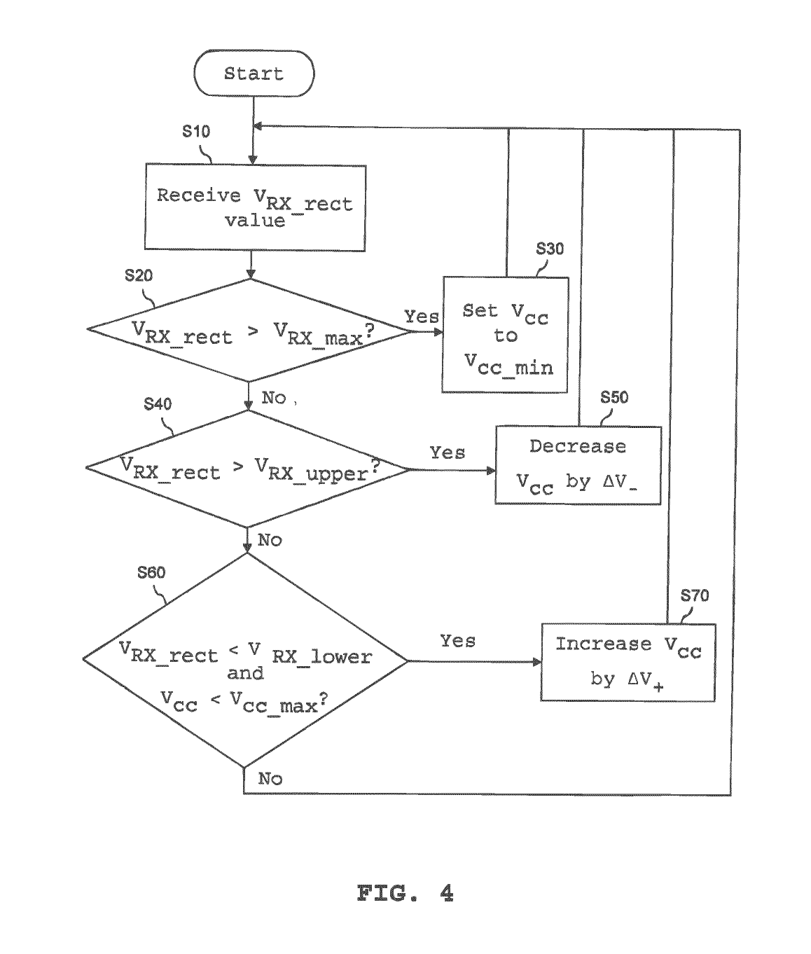

An example of the process by which the microcontroller 120-1 controls the amplitude of the voltage V_{cc} output by the DC power supply 111-1 based on a feedback signal that has been received by the FSK data receiver 130-1 will now be described with reference to FIG. 4.

In step S10, the FSK data receiver 130-1 receives from the FSK data transmitter 250-1 a feedback signal in the form of data indicative of the measured output voltage V_{RX}_{_}_{rect} of the bridge rectifier 212-1 that has been measured by the microcontroller 240-1. The received data may, as in the present embodiment, contain values of V_{RX}_{_}_{rect} that have been sampled by the microcontroller 240-1 (although normalised values of V_{RX}_{_}_{rect}, or otherwise processed values that are indicative of V_{RX}_{_}_{rect}, may alternatively be used). The received data is then communicated to the microcontroller 120-1.

In step S20, the microcontroller 120-1 performs a test to determine whether the received value of V_{RX}_{_}_{rect} is greater than a maximum permitted voltage, V_{RX}_{_}ₘₐₓ, above which the receiver circuit 210-1 would sustain damage. In the present embodiment, V_{RX}_{_}ₘₐₓ=60 V. If the microcontroller 120-1 determines that V_{RX}_{_}_{rect}>V_{RX}_{_}ₘₐₓ then, in step S30, it sets the DC voltage V_{cc} to a value of V_{cc}_{_}ₘᵢₙ, which is set low enough to ensure that the rectified induced voltage V_{RX}_{_}_{rect} will be within safe limits (i.e. low enough not to cause damage to the receiver circuit 210-1), regardless of how closely the coils 113-1 and 211-1 are positioned in relation to one another. Thus, if the power reception device 200-1 is moved towards the power transmission device too quickly for the regulation loop (described in detail below) to respond, the microcontroller 120-1 ensures that the transmitted power is rapidly reduced to a safe level. The process then loops back to step S10.

On the other hand, if the microcontroller 120-1 determines that V_{RX}_{_}_{rect}<V_{RX}_{_}ₘₐₓ, then the process proceeds to step S40, wherein the microcontroller 120-1 determines whether V_{RX}_{_}_{rect} is greater than the upper limit, V_{RX}_{_}ᵤₚₚₑᵣ, of a target band of voltages, which is between 45 V and 55 V in the present embodiment. If the microcontroller 120-1 determines that V_{RX}_{_}_{rect}>V_{RX}_{_}ᵤₚₚₑᵣ, then it decrements V_{cc} by a voltage step ΔV₋ (e.g. 2 V) in step S50, and process then loops back to step S10.

However, if V_{RX}_{_}_{rect} is not greater than V_{RX}_{_}ᵤₚₚₑᵣ, then the microcontroller 120-1 determines in step S60 whether V_{RX}_{_}_{rect} is smaller than the lower limit, V_{RX}_{_}_{lower}, of the target band of voltages. The microcontroller 120-1 also determines in step 860 whether the currently set value of V_{cc} is smaller than a maximum permitted voltage, V_{cc}_{_}ₘₐₓ, above which power transmission module 110-1 would sustain damage. In the present embodiment, V_{cc}_{_}ₘₐₓ is set so as to keep the source-drain voltage across the transistor (e.g. MOSFET) S₁ in the Class-E inverter less than 1000 V, which is its breakdown voltage. If the microcontroller 120-1 determines that both V_{RX}_{_}_{rect}<V_{RX}_{_}_{lower} and V_{cc}<V_{cc}_{_}ₘₐₓ, then the process proceeds to step 870, wherein the microcontroller 120-1 increments V_{cc} by a voltage step ΔV₊, which is of the same size as ΔV₋ in the present embodiment (although the sizes of ΔV₊ and ΔV₋ need not be the same in general). The process then loops back to step S10. On the other hand, if one or both of the conditions tested for in step S60 is not fulfilled, the process proceeds from step S60 directly to back to step S10.

In this way, the microcontroller 120-1 regulates the transmission power by controlling V_{cc} to remain within the aforementioned hysteresis band of 45-55 V, which is chosen to ensure satisfactory voltage stability at the output of the receiver circuit 210-1.

### [Experimental Results]

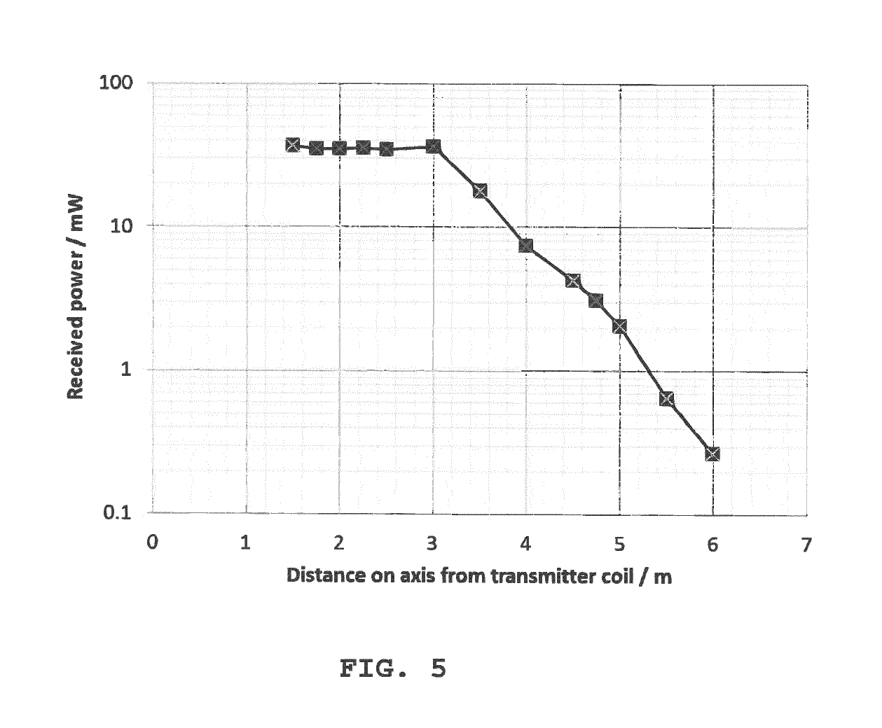

FIG. 5 is a log-linear plot showing how the measured received power varies as a function of the distance between the transmission coil 113-1 and the receiver coil 211-1 in an embodiment of the present invention. As shown in this figure, at distances below 3 m, the received power was essentially constant as the distance between the coils was varied. At distances greater than 3 m, V_{CC} was limited to the maximum value of V_{CC}_{_}ₘₐₓ by the microcontroller 120-1, causing the received power to decrease with increasing coil separation.

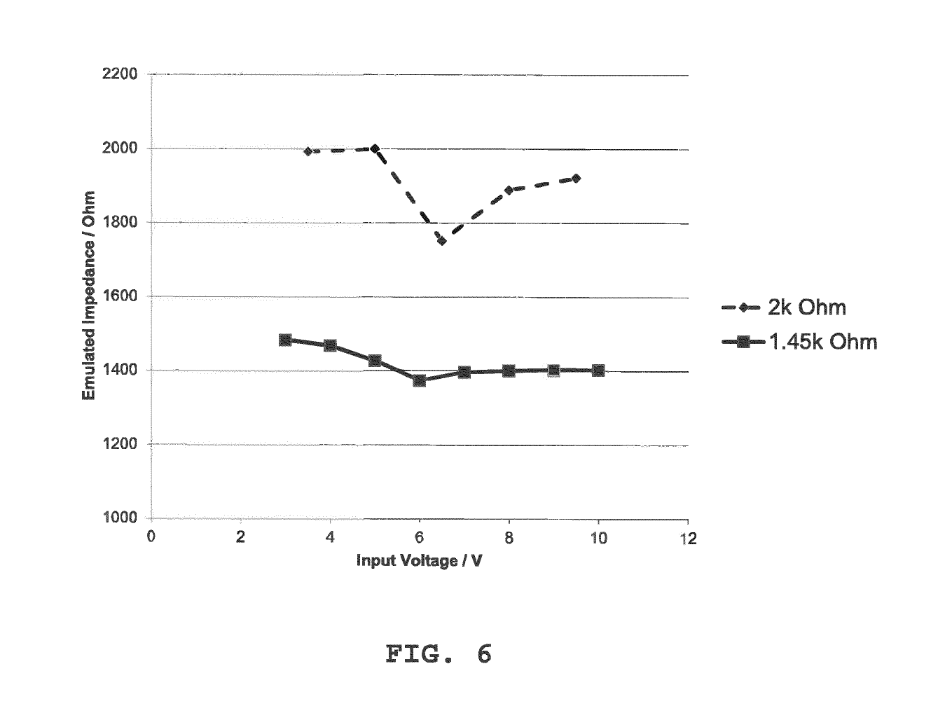

FIG. 6 demonstrates the effectiveness of the impedance emulator 220 in keeping the impedance at its input substantially constant. More particularly, FIG. 6 shows the results of two experiments, wherein the effective impedance of the impedance emulator was found to vary around its optimal value (namely, 2 kΩ and 1.45 kΩ) by about 10% or less as its input DC voltage changed from 3 V to 10 V.

1. A near-field inductive power transfer system (10), comprising:
a power transmission device (100) arranged to transmit power wirelessly at a first frequency, f₀; and
a power reception device (200) arranged to receive power transmitted by the power transmission device (100), the power reception device (200) being moveable relative to the power transmission device (100) and comprising:
a receiver circuit (210) configured to receive power for powering a variable load (230) when the power reception device (200) is in a near-field region of the power transmission device (100), the receiver circuit being a resonant circuit with a resonant frequency, f_{R}, such that 0.2<f₀/f_{R}<3; and
an impedance emulator (220) for providing the received power to the variable load (230), the impedance emulator being arranged to suppress a variation in an impedance presented to the receiver circuit (210) by the load when the load varies during use of the near-field inductive power transfer system (10).

2. A near-field inductive power transfer system (10) according to claim 1, wherein the impedance emulator (220) comprises a switched mode DC-DC converter configured to draw a level of power from the receiver circuit (210) that is substantially unchanged when the load (230) varies during use of the near-field inductive power transfer system (10).

3. A near-field inductive power transfer system (10) according to claim 2, wherein the switched mode DC-DC converter comprises one of:
a zeta converter;
a flyback converter;
a buck-boost converter;
a SEPIC converter;
a Ćuk converter;
a boost converter with a step-up voltage conversion ratio M such that M>>1; and
a buck converter with a step-down voltage conversion ratio R such that R>>1.

4. A near-field inductive power transfer system (10) according to claim 1, wherein
the power reception device (200) further comprises:
a voltage monitor (240) arranged to measure the output voltage, V_{RX}_{_}_{rect}, of the receiver circuit (210); and
a feedback signal transmitter (250) arranged to transmit a feedback signal indicative of the measured output voltage V_{RX}_{_}_{rect} to the power transmission device (100), and
the power transmission device (100) comprises:
a feedback signal receiver (130) arranged to receive the signal indicative of the measured output voltage V_{RX}_{_}_{rect} transmitted by the feedback signal transmitter (250); and
a transmission power controller (120) arranged to control the power transmitted by the power transmission device (100) in dependence upon the received feedback signal.

5. A near-field inductive power transfer system (10) according to claim 4, wherein the transmission power controller (120) is arranged to regulate the power transmitted by the power transmission device (100) by monitoring a difference between the measured output voltage V_{RX}_{_}_{rect} and a reference voltage, and adjusting the transmitted power based on the monitored difference.

6. A near-field inductive power transfer system (10) according to claim 4, wherein the transmission power controller (120) is further arranged to control the transmitted power to remain below a first limit so as to prevent damage to the power transmission device (100).

7. A near-field inductive power transfer system (10) according to claim 4, wherein the transmission power controller (120) is further arranged to compare the measured output voltage V_{RX}_{_}_{rect} with a threshold voltage and, when the measured output voltage V_{RX}_{_}_{rect} exceeds the threshold voltage, cause the power transmission device (100) to cease transmitting power or to transmit power at a reduced level, so as to prevent damage to the power reception device (200).

8. A mobile power reception device (200) for receiving power that has been transmitted wirelessly by a power transmission device (100) at a first frequency, f₀, the power reception device (200) comprising:
a receiver circuit (210) configured to receive power for powering a variable load (230) when the power reception device is in a near-field region of the power transmission device (100), the receiver circuit being a resonant circuit with a resonant frequency, f_{R}, such that 0.2<f₀/f_{R}<3; and
an impedance emulator (220) for providing the received power to the variable load (230), the impedance emulator being arranged to suppress a variation in an impedance presented to the receiver circuit (210) by the load when the load varies during use of the near-field inductive power transfer system (10).

9. A mobile power reception device (200) according to claim 8, wherein the impedance emulator (220) comprises a switched mode DC-DC converter configured to draw a level of power from the receiver circuit (210) that is substantially unchanged when the load (230) varies during use of the near-field inductive power transfer system (10).

10. A mobile power reception device (200) according to claim 9, wherein the switched mode DC-DC converter comprises one of:
a zeta converter;
a flyback converter;
a buck-boost converter;
a SEPIC converter;
a Ćuk converter;
a boost converter with a step-up voltage conversion ratio M such that M>>1; and
a buck converter with a step-down voltage conversion ratio R such that R>>1.

11. A mobile power reception device (200) according to claim 8, further comprising:
a voltage monitor (240) arranged to measure the output voltage, V_{RX}_{_}_{rect}, of the receiver circuit (210); and
a feedback signal transmitter (250) arranged to transmit a feedback signal indicative of the measured output voltage V_{RX}_{_}_{rect} to the power transmission device (100), for use by the power transmission device to control the power transmitted thereby.

12. A power transmission device (100) for transmitting power wirelessly to a mobile power reception device (200) at a frequency f₀ when the power reception device is in a near-field region of the power transmission device, the power reception device (200) comprising a resonant circuit having a resonant frequency f_{R} such that 0.2<f₀/f_{R}<3, the power transmission device (100) comprising:
a power transmission module (110) for transmitting power wirelessly to the power reception device (200);
a feedback signal receiver (130) operable to receive from the power reception device (200) a feedback signal indicative of an output voltage, V_{RX}_{_}_{rect}, of the resonant circuit measured by the power reception device; and
a transmission power controller (120) arranged to control the power transmitted by the power transmission module (110) in dependence upon the received feedback signal.

13. A power transmission device (100) according to claim 12, wherein the transmission power controller (120) is arranged to regulate the power transmitted by the power transmission module (110) by monitoring a difference between the measured output voltage V_{RX}_{_}_{rect} and a reference voltage, and adjusting the transmitted power based on the monitored difference.

14. A power transmission device (100) according to claim 12, wherein the transmission power controller (120) is further arranged to control the transmitted power to remain below a first limit so as to prevent damage to the power transmission device (100).

15. A power transmission device (100) according to claim 12, wherein the transmission power controller (120) is further arranged to compare the measured output voltage V_{RX}_{_}_{rect} with a threshold voltage and, when the measured output voltage V_{RX}_{_}_{rect} exceeds the threshold voltage, cause the power transmission module (110) to cease transmitting power or to transmit power at a reduced level, so as to prevent damage to the power reception device (200).
